(19) United States
(12) Patent Application Publication
(10) Pub. No.: US 2024/0403655 A1
(43) Pub. Date: Dec. 5, 2024

(54) FEDERATED LEARNING SIMULATOR FOR FLEXIBLE LOCAL AND GLOBAL TRAINING

(71) Applicant: Dell Products L.P., Round Rock, TX (US)

(72) Inventors: Paulo Abelha Ferreira, Rio de Janeiro (BR); Pablo Nascimento da Silva, Niterói (BR); Isabella Costa Maia, São Paulo (BR); Iam Palatnik de Sousa, Rio de Janeiro (BR)

(21) Appl. No.: 18/326,885

(22) Filed: May 31, 2023

(51) Int. Cl. G06N 3/098

(52) U.S. Cl. CPC G06N 3/098

(57) ABSTRACT

One example method includes, for each federated learning simulation, defining a machine learning model that is used in the federated learning simulation. The machine learning model has associated variables and is implemented at edge nodes and a central node of the federated learning simulation. A first variable list is defined that specifies associated variables that are to be optimized at the edge nodes of the federated learning simulation. A second variable list is defined that specifies associated variables that are to be provided by the edge nodes to the central node of the federated learning simulation. The associated variables included in the first variable list are optimized at the edge nodes of federated learning simulation. The associated variables that are included in the second variable list and that are provided by the edge nodes of the federated learning simulation are aggregated by the central node of the federated learning simulation.

### FIELD OF THE INVENTION

Embodiments of the present invention generally relate to federated learning processes. More particularly, at least some embodiments of the invention relate to systems, hardware, software, computer-readable media, and methods for simulating variable optimization and aggregation at both edge nodes and a central node.

### BACKGROUND

Federated Learning (FL) is a strategy for distributed training of Machine Learning (ML) models, where multiple nodes contribute to the training with their own separate datasets. The key benefit of FL is keeping the data private at each edge node while still being able to leverage it to train a common model. This is possible because in FL each edge node communicates its locally trained model instead of the data and models from all nodes are aggregated at a central node and synced back to the edge, where this cycle continues as needed.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of Federated Learning (FL);

FIG. 2 discloses aspects of variables used in FL;

FIG. 3 illustrates aspects of four different types of variables used in a FL system;

FIG. 4A illustrates aspects of a model simulation service;

FIG. 4B illustrates aspects of a local train variable list and a federation variable list;

FIG. 4C illustrates aspects of an aggregation map;

FIGS. 5A and 5B illustrates aspects of a simulation of an FL system;

FIG. 6 illustrates aspects of a method for simulating a FL system; and

FIG. 7 illustrates aspects of an example computing system in which the embodiments described herein may be employed.

### DETAILED DESCRIPTION OF SOME EXAMPLE EMBODIMENTS

Embodiments of the present invention generally relate to federated learning processes. More particularly, at least some embodiments of the invention relate to systems, hardware, software, computer-readable media, and methods for simulating variable optimization and aggregation at both edge nodes and a central node.

One example method includes, for each federated learning simulation, defining a machine learning model that is used in the federated learning simulation. The machine learning model has associated variables and is implemented at edge nodes and a central node of the federated learning simulation. A first variable list is defined that specifies associated variables that are to be optimized at the edge nodes of the federated learning simulation. A second variable list is defined that specifies associated variables that are to be provided by the edge nodes to the central node of the federated learning simulation. The associated variables included in the first variable list are optimized at the edge nodes of the federated learning simulation. The associated variables that are included in the second variable list and that are provided by the edge nodes of the federated learning simulation are aggregated by the central node of the federated learning simulation.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. Also, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that a way is provided to simulate the optimization and aggregation of different types of variables in a FL system including: (1) a locally optimized variable, where the variable is updated/optimized locally, but not aggregated, (2) a local information variable, where the variable is not updated/optimized, but it is aggregated, (3) a standard federated variable, where the variable is both updated/optimized and aggregated, and (4) a locally frozen variable, where the variable is neither updated/optimized nor aggregated. In existing FL system simulators, there is no way to simulate the above four types of variables. Thus, the embodiments of the invention disclosed herein provide enhanced ability to simulate FL systems to thereby determine optimal deployments of the FL system.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of Federated Learning (FL) System

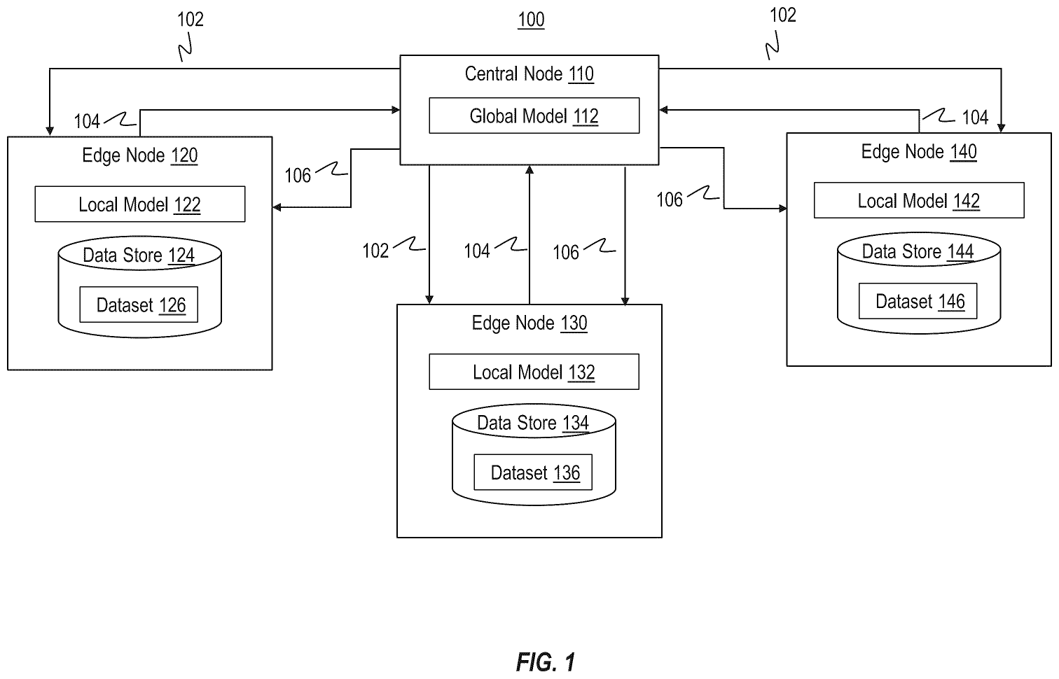

FIG. 1 illustrates an embodiment of an FL system 100. As illustrated, a central node 110 provides an initial global model 112 to an edge node 120, an edge node 130, and an edge node 140 as shown at 102. The edge node 120 includes a local model 122 and a local data store 124 that stores a local dataset 126. The edge node 130 includes a local model 132 and a local data store 134 that stores a local dataset 136. The edge node 140 includes a local model 142 and a local data store 144 that stores a local dataset 146. The global model 112 and the local models 122, 132, and 142 may be any reasonable ML model such as, but not limited to, deep neural networks, convolutional neural networks, multilayer neural networks, recursive neural networks, logistic regressions, isolation forests, k-nearest neighbors, support vector machines (SVM), or any other reasonable machine-learning model. It will be understood that the local models are local versions of the global model that is provided to the edge nodes by the central node during an initial cycle.

The edge node 120 performs local training on the local model 122 using the local dataset 126. Likewise, the edge node 130 performs local training on the local model 132 using the local dataset 136. In similar manner, the edge node 140 performs local training on the local model 142 using the local dataset 146.

As a result of the local training, the local models 122, 132, and 142 are updated to fit the local datasets 126, 136, and 146 respectively to the global model 112. As shown at 104, the updated local models 122, 132, and 142 are sent by the edge nodes to the central node 110, which aggregates the updates of all edge nodes to obtain an updated global model 112. This new updated global model 112 is then sent back to the edge nodes 120, 130, and 140 as shown at 106 and become the local models 122, 132, and 142. This cycle is repeated iteratively for a user determined amount of update rounds.

### B. Aspects of Variables Used in FL

As some aspects of the embodiments disclosed herein are related to variables, a discussion of such variables will now be given. As mentioned previously, the ML model that is optimized and aggregated using FL can be one of various types of models such as those listed in relation to FIG. 1. Thus, each different model may have different variables associated with it and/or may define what a variable is differently. In some embodiments, a variable is a model variable that is a mathematical representation of what the ML model is trying to predict or optimize. For example, in one embodiment a variable can be defined as a particular tensor of a given neural network layer. In addition, a variable can also be related to the ML model, but not directly be a part of the model. For example, in one embodiment a variable may be model statistics or a value such as the number of data samples used by the ML model. In further embodiments, a variable can be data that is useful to particular ML model and is thus frozen so as to be reusable by the model. For example, if the ML model was related to optimizing factory output, perhaps the a frozen variable would be the location of the factory as this information would be useful for the ML model to know each time it performed its optimization. However, the location of the factory might not be relevant to other models. Accordingly, the embodiments and claims disclosed herein are not limited to any particular definition or determination of what constitutes a variable as there are any number of reasonable ways to define and determine such variables.

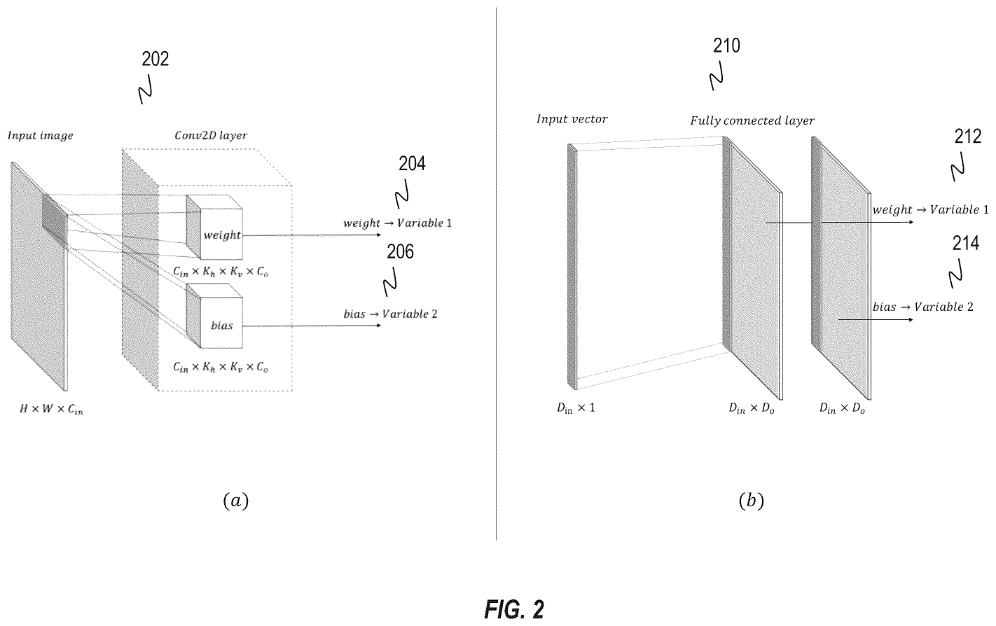

In one embodiment, a variable is defined as a particular tensor of a given neural network layer, where the neural network is a set of connected layers, where each layer contains one or more variables. For example, FIG. 2 example (a) illustrates a convolutional 2D layer 202 that is made up of two variables, namely a weight variable 204 and a bias variable 206. FIG. 2 example (b) illustrates a simple fully connected layer 210 that is made up of two variables, namely a weight variable 212 and a bias variable 214.

However, it is also possible to have layers that have additional variables. For example, a 2D Batch Normalization layer (not illustrated) can be made of four variables, namely a weight variable, a bias variable, a running mean variable, and a running variance variable, where running mean and running variance are statistical variables of the layer.

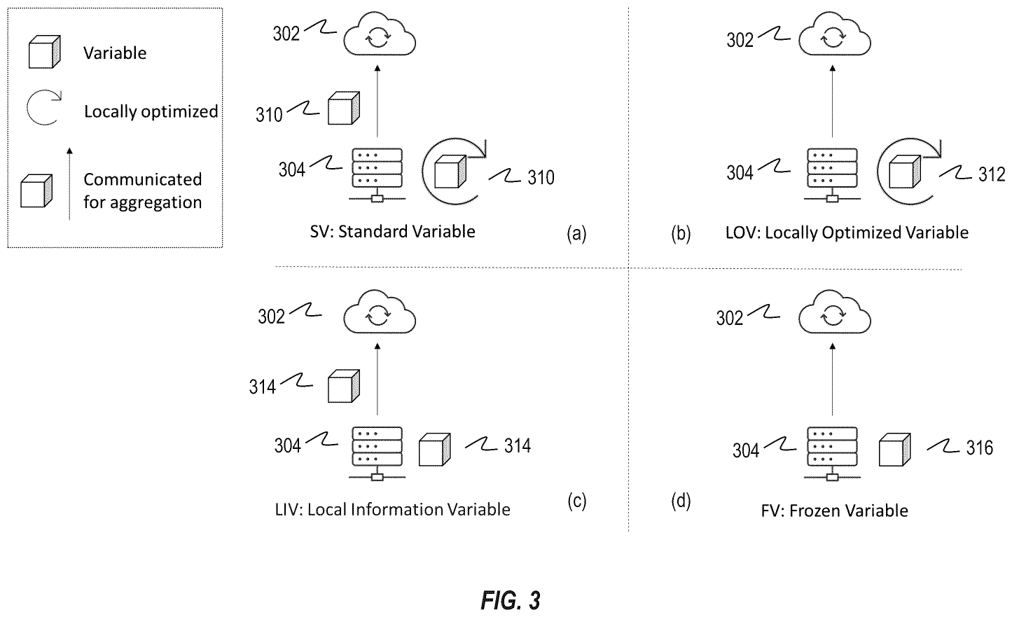

FIG. 3 illustrates four different types of variables that can be used by an FL system. As illustrated, FIG. 3 example (a) shows an example of a standard variable. A standard variable is a variable that is both locally optimized and globally aggregated. A classic example is the weight or bias variable for a fully connected layer that is trained and aggregated. A standard variable will be locally optimized during training by an edge node and communicated to the central node. In FIG. 3 example (a), the standard variable 310 is shown as being optimized at an edge node 304, which may correspond to edge nodes 120, 130, and 140, and then being communicated to a central node 302, which may correspond to central node 110, for aggregation.

FIG. 3 example (b) shows an example of a locally optimized variable. A locally optimized variable is a variable that is locally optimized during training by the edge node 304, but that is not considered for aggregation at the central node 302. That is, a locally optimized variable will not be communicated to the central node. An example of a locally optimized variable might be the last layer of a ML model used for fine-tuning the model. That is, since the variable is used to fine-tune the ML model, there is no need for the other nodes in the federation to have access to the locally optimized variable. In FIG. 3 example (b) the locally optimized variable 312 is shown as being optimized at the edge node 304, but is not communicated to the central node 302 for aggregation.

FIG. 3 example (c) shows an example of a local information variable. A local information variable is a variable that is not optimized during training by the edge node 304, but that is, nonetheless, communicated to central node 302 for aggregation. A classic example of a local information variable is the running mean or running variance (i.e., model statistics) of a Batch Normal 2D layer, which, for certain use cases, might be calculated locally at the edge node 304 (i.e., not optimized) and aggregated globally at the central node 302. That is, the model statistics might be needed by other nodes in the federation and so they are sent for aggregation even though they do not need to be locally optimized. In FIG. 3 example (c) the local information variable 314 is shown as not being optimized at the edge node 304, but is communicated to the central node 302 for aggregation. Example methods and systems for aggregating the running mean or running variance in a BatchNorm2D layer are disclosed in U.S. patent application Ser. No. 18/154,407 entitled FEDERATED GLOBAL BATCH NORMALIZATION WITH SECURE AGGREGATION FOR FEDERATED LEARNING, filed Jan. 13, 2023, which is incorporated herein by reference in its entirety.

FIG. 3 example (d) shows an example of a frozen variable. A frozen variable is a variable that is neither locally optimized by the edge node 304 nor is it communicated to the central node 302 for aggregation. One example of a frozen variable is the running mean or running variance of a Batch Normal 2D layer, which, for certain use cases, might be calculated locally at the edge node 304 (i.e., not optimized) and not aggregated globally at the central node 302 as it might be preferable to keep the statistic tracking local. Another example of a frozen variable is the information discussed above that is only relevant to the ML model running on the edge node 304 and thus is not needed by the other edge nodes of the federation. In FIG. 3 example (d) the frozen variable 316 is shown as not being optimized at the edge node 304 and also not communicated to the central node 302 for aggregation.

### C. Aspects of Some Example Embodiments

Although the FL system 100 may be deployed in operation by a user, it is often advantageous to first simulate the FL system before the system is deployed. In this way, a user is able to optimize the FL system before it is deployed. In addition, simulation allows for research and further development of FL systems without the cost of actually deploying the FL system.

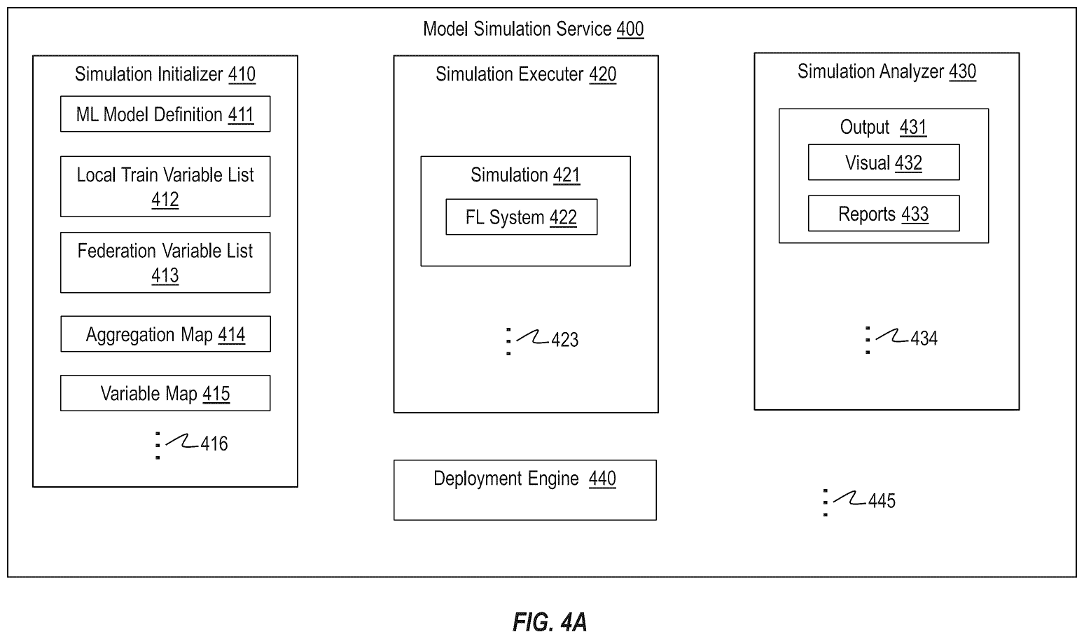

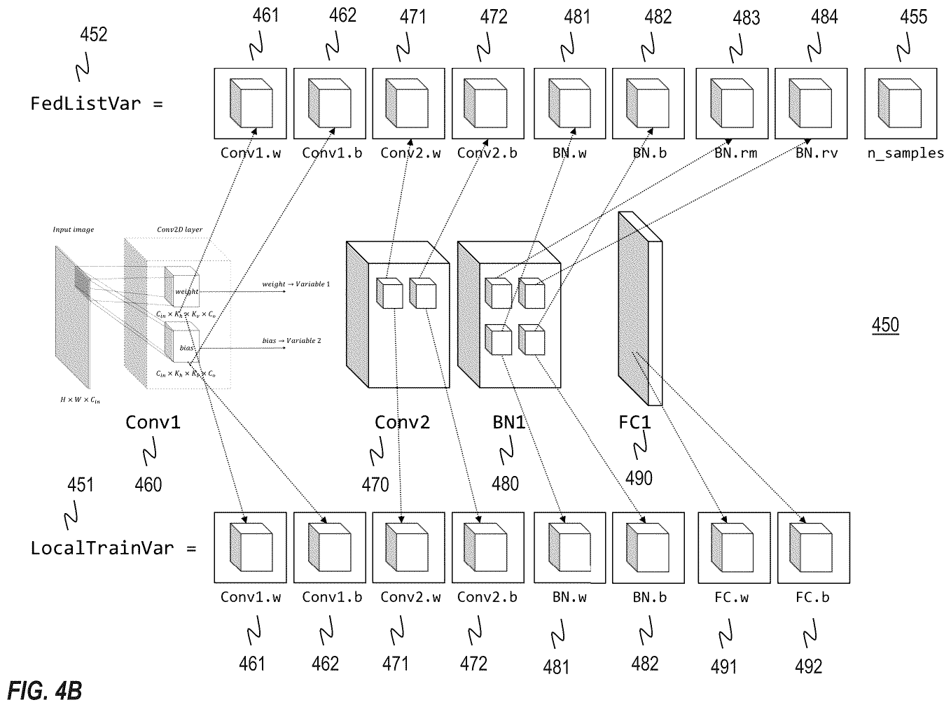

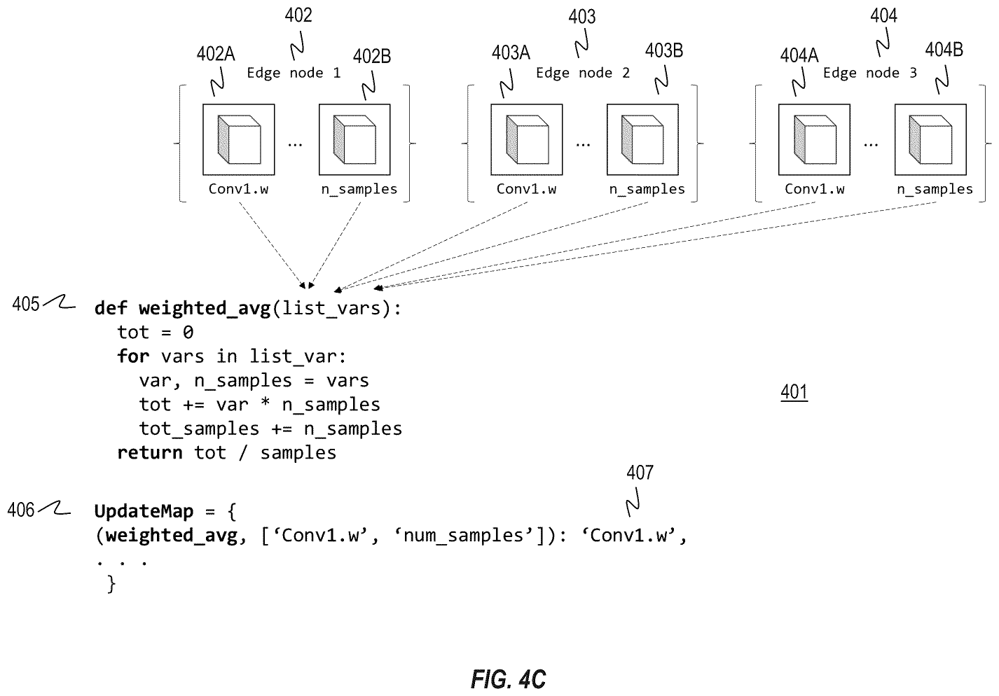

Accordingly, the embodiments disclosed herein include a model simulation service 400 illustrated in FIG. 4A. In operation, the model simulation service 400 provides a framework for evaluating different FL systems and the ML models that are implemented in the system. An example framework for a model simulation service such as the model simulation service 400 is disclosed in U.S. patent application Ser. No. 17/081,710 entitled FRAMEWORK FOR RAPIDLY PROTOTYPING FEDERATED LEARNING ALGORITHMS, filed Oct. 27, 2020, which is incorporated herein by reference in its entirety.

In the current embodiment, the model simulation service 400 provides the novel ability to perform simulations that take into account a standard variable such as standard variable 310, a locally optimized variable such as locally optimized variable 312, a local information variable such as local information variable 314, and a frozen variable such as frozen variable 316. Such an ability is not currently found in existing simulation services.

Accordingly, the model simulation service 400 includes a simulation initializer 410. In operation, the simulation initializer 410 allows a user to define a strategy for the FL system and its training. For example, the user is able to provide a ML model definition 411. The ML model definition defines the ML model whose training will be simulated by the model simulation service 400.

The user is also able to define a local train variable list 412 and a federation variable list 413. The local train variable list 412 is a list of variables such the ML model variables and those related to the ML model discussed previously in relation to FIG. 2 that are to be used by a simulated edge node for local training of the defined ML model. The federation variable list 413 defines the variables that will be sent to the simulated central node for aggregation into the global defined ML model and for other uses at the central node. This list includes the variables optimized by the edge node and the variables that are not directly part of, but are related to, the ML model such as the model statistics.

FIG. 4B illustrates an embodiment of a ML model 450 that corresponds to the ML model definition 411 of the model simulation service 400. As illustrated, the ML model 450 includes a first convolution layer 460, second convolution layer 470, a batch normal layer 480, and a fully connected layer 490. The first convolution layer 460 is made up of a weight variable 461 and a bias variable 462. The second convolution layer 470 is made up of a weight variable 471 and a bias variable 472. The batch normal layer 480 is made up of a weight variable 481, a bias variable 482, a running mean variable 483, and a running variance variable 484. The fully connected layer 490 is made up of a weight variable 491 and a bias variable 492. In addition, there is a variable that is not part of the ML model 450, but is related to model, which is the number of samples variable 455.

FIG. 4B also shows an embodiment of a local train variable list 451 that corresponds to the local train variable list 412. As illustrated, the local train variable list 451 includes the weight variable 461, the bias variable 462, the weight variable 471, the bias variable 472, the weight variable 481, the bias variable 482, the weight variable 491, and the bias variable 492. Accordingly, these variables will be locally optimized at an edge node such as the edge node 304.

FIG. 4B further shows an embodiment of a federation variable list 452 that corresponds to the federation variable list 413. As illustrated, the federation variable list 452 includes the weight variable 461, the bias variable 462, the weight variable 471, the bias variable 472, the weight variable 481, the bias variable 482, the running mean variable 483, the running variance variable 484, and the number of samples variable 455. Accordingly, these variables will be communicated to a central node such as the central node 302 for aggregation.

The weight variable 461, the bias variable 462, the weight variable 471, the bias variable 472, the weight variable 481, and the bias variable 482 are examples of standard variables since they are included on both the local train variable list 451 and the federation variable list 452. Thus, these variables will be locally optimized at the edge node and then communicated to the central node for aggregation. The weight variable 491 and the bias variable 492 are examples of locally optimized variables since they are only included on the local train variable list 451. Thus, these variables will be locally optimized at the edge node, but will not be communicated to the central node for aggregation. The running mean variable 483, the running variance variable 484, and the number of samples variable 455 are examples of local information variables since they are only included on the federation variable list 452. Thus, these variables are not locally optimized at the edge node, but are communicated to the central node for aggregation.

The user is also able to define an aggregation map 414 and a variable map 415 using the simulation initializer 410. The aggregation map 414 allows the user to define a function to use for aggregating the variables in the federation variable list. Examples of functions include weighted average, simple average, majority voting, and random selection. Thus, the user is given flexibility in specifying how aggregation is done. The variable map 415 allows the user to define how the edge nodes will gather the variables that are related to a model, but are not part of the model, such as the number of samples variable 455 or a frozen variable at the edge node. In some embodiments, the variable map may map the relevant variable to a function that is implemented at the edge node that specifies how to obtain the related variables. The ellipses 416 represent that the simulation initializer 410 can have any number of additional functions in addition to those described herein.

FIG. 4C illustrates an embodiment of an aggregation map 401 that corresponds to the aggregation map 414. As shown in FIG. 4C, an edge node 402 has a weight variable 402A and a number of samples variable 402B, an edge node 403 has a weight variable 403A and a number of samples variable 403B, and an edge node 404 has a weight variable 404A and a number of samples variable 404B.

FIG. 4C also illustrates an aggregation function 405 that defines how the aggregation of the variables will be performed. In the illustrated embodiment, the aggregation function 405 is a weighted average function that determines a weighted average of the weight variables of each edge node based on their respective number of samples variables, where the number of samples is the number of samples used for training each of the edge nodes.

FIG. 4C also illustrates an update map 406. The update map 406 specifies that the weighted average is used to aggregate weight variable 402A, weight variable 403A, and weight variable 404A into a single new aggregated weight variable 407. Thus, the aggregated weight variable 407 will replace the weight variables 402A, 403A, and 404A and will be sent as an update to the edge nodes 402, 403, and 404 for updating of their respective local models.

The model simulation service 400 also includes a simulation executer 420. In operation, the simulation executer 420 uses the various elements defined by the simulation initializer to generate a simulation 421 of a FL system 422. The ellipses 423 represent that the simulation executer 420 can have any number of additional functions in addition to those described herein.

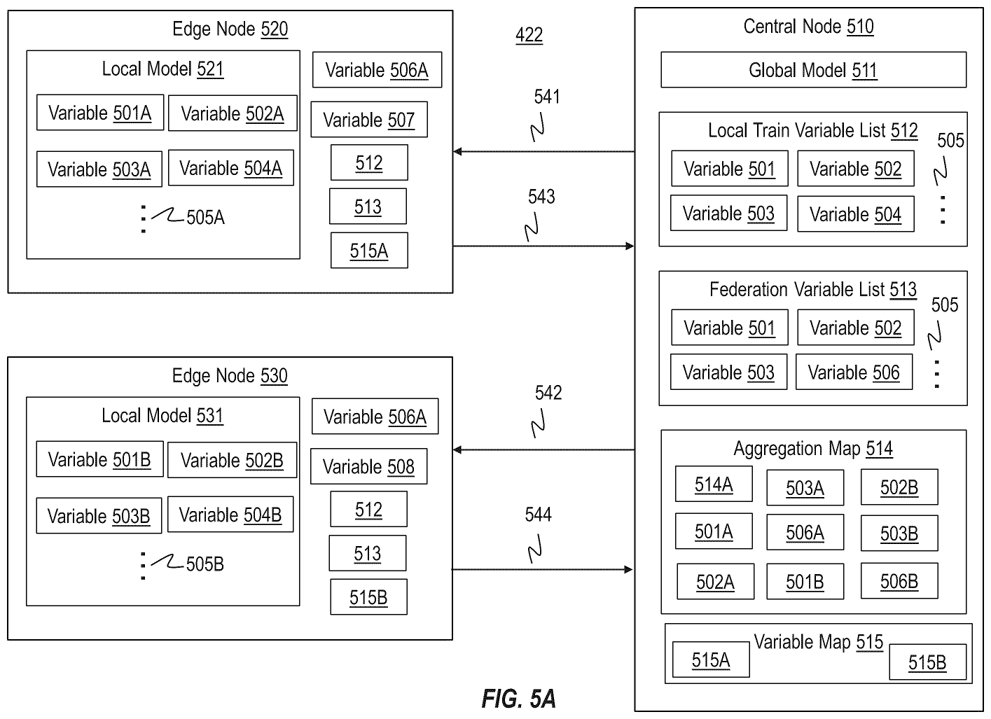

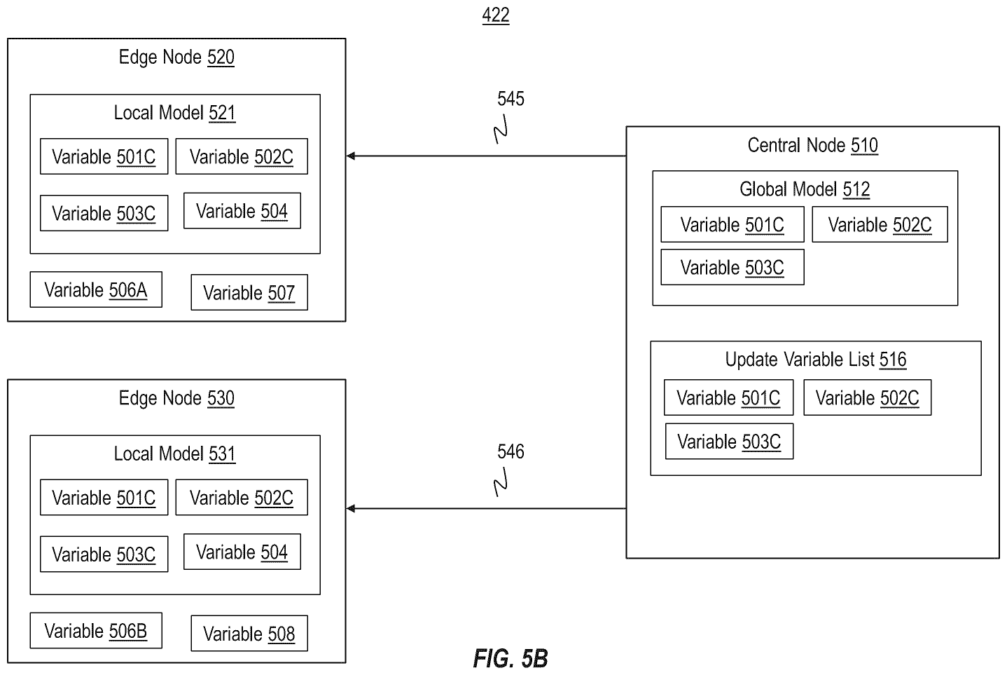

FIGS. 5A and 5B illustrate an embodiment of the simulated FL system 422 that is simulated by the simulation executer 420 during a federated learning cycle or round. As illustrated, the simulated FL system 422 includes a central node 510, which may correspond to the central node 110 or 302 previously described. The central node 510 includes a global ML model 511, which corresponds to the ML model definition 411. The central node 510 also includes a local train variable list 512 which corresponds to the local train variable list 412. In the embodiment, the local train variable list 512 includes variables 501, 502, 503, 504, and any number of additional variables 505 as illustrated by the ellipses that are to be optimized at the various edge nodes. The variables 501, 502, 503, and 504 may correspond to any of the variables 461, 462, 471, 472, 481-484, 491, and 492 previously described. The central node 510 further includes a federation variable list 513 which corresponds to the federation variable list 413. In the embodiment, the federation variable list 513 includes variables 501, 502, 503, 506, and any number of additional variables 505 as illustrated by the ellipses that are to be communicated from the edge nodes to the central node 510.

The simulated FL system 422 also includes an edge node 520 and an edge node 530, which may correspond to any of the edge nodes 120, 130, 140, and 304 previously described. Although not illustrated for ease of explanation, the simulated FL system 422 could also include any number of additional edge nodes whose operation would be the same as edge nodes 520 and 530. The edge node 520 includes a local ML model 521 that includes variables 501A, 502A, 503A, 504A, and any number of additional variables 505A as illustrated by the ellipses and that corresponds to the ML model definition 411. The edge node 520 further includes a variable 506A and a variable 507 that are not model variables, but may correspond to local information variables that comprise model statistics or that comprise information or knowledge that is specific to the local model 521 as previously described. It will be appreciated that the variables 501A, 502A, 503A, 504A, 505A, and 506A correspond to the variables 501, 502, 503, 504, 505, and 506, but are marked with an “A” to illustrate that these variables are local versions of the variables at the edge node 520.

The edge node 530 includes a local ML model 531 that includes variables 501B, 502B, 503B, 504B, and any number of additional variables 505B as illustrated by the ellipses and that corresponds to the ML model definition 411. The edge node 530 further includes a variable 506B and a variable 508 that are not model variables, but may correspond to local information variables that comprise model statistics or that comprise information or knowledge that is specific to the local model 531 as previously described. It will be appreciated that the variables 501B, 502B, 503B, 504B, 505B, and 506B correspond to the variables 501, 502, 503, 504, 505, and 506, but are marked with a “B” to illustrate that these variables are local versions of the variables at the edge node 530. It will also be appreciated that the inclusion of the variables 507 and 508 shows that the edge nodes 520 and 530 can have different non-model variables since each can have knowledge that is specific to their respective local models that would not be included in a different edge node.

At the start of a federated learning cycle or round, the central node 510 communicates the local train variable list 512 and the federation variable list 513 to the edge node 520 as shown at 541 and to the edge node 530 as shown at 542. Although not shown for ease of explanation, the local train variable list 512 and the federation variable list 513 would also be sent to any other edge nodes of the simulated FL system 422. Once received, the edge node 520 uses the local train variable list 512 to determine which variables to optimize during a local training process. In the embodiment, the edge node 520 optimizes the variables 501A, 502A, 503A, and 504A since these variables are included in the local train variable list 512. Likewise, once received, the edge node 530 uses the local train variable list 512 to determine which variables to optimize during the local training process. In the embodiment, the edge node 530 optimizes the variables 501B, 502B, 503B, and 504B since these variables are included in the local train variable list 512.

The edge node 520 then uses the federation variable list 513 to determine the variables to be communicated to the central node 510. For example, the edge node 520 runs through all the variables that are part of the local model 521 and also those that are not part of the local model and selects only the variables included in the federation variable list 513. In the embodiment, the edge node 520 selects and then communicates the variables 501A, 502A, 503A, and 506A to the central node as shown at 543 since only these variables are included in the federation variable list 513. It will be noted that although the variable 504A was optimized, it is not communicated to the central node 510 since it is not on the federation variable list 513 and thus is an example of a locally optimized variable. In addition, the variable 507 is neither optimized nor communicated to the central node 510 since this variable is not on either the local train variable list 512 or the federation variable list 513 and thus is an example of a frozen variable.

Likewise, the edge node 530 uses the federation variable list 513 to determine the variables to be communicated to the central node 510. For example, the edge node 530 runs through all the variables that are part of the local model 531 and also those that are not part of the local model and selects only the variables included in the federation variable list 513. In the embodiment, the edge node 530 selects and then communicates the variables 501B, 502B, 503B, and 506B to the central node as shown at 544 since only these variables are included in the federation variable list 513. It will be noted that although the variable 504B was optimized, it is not communicated to the central node 510 since it is not on the federation variable list 513 and thus is an example of a locally optimized variable. In addition, the variable 508 is neither optimized nor communicated to the central node 510 since this variable is not on either the local train variable list 512 or the federation variable list 513 and thus is an example of a frozen variable.

The central node 510 includes an aggregation map 514 which corresponds to the aggregation map 414. The aggregation map 514 includes an aggregation function 514A that is used for aggregating the variables in the federation variable list 513 received from the edge nodes 520 and 530 and that corresponds to the aggregation function 405. In the embodiment, the variables 501A, 502A, 503A, 506A, 501B, 502B, 503B, and 506A are aggregated using the aggregation function 514A since these variables were included in the federation variable list 513. The variables 501A, 502A, and 503A were optimized by the edge node 520 and then communicated to the central node 510 for aggregation and thus are examples of standard variables. In addition, the variable 506A was not optimized by the edge node 520 but was communicated to the central node 510 and thus is an example of a local information variable. The variables 501B, 502B, and 503B were optimized by the edge node 530 and then communicated to the central node 510 for aggregation and thus are examples of standard variables. In addition, the variable 506B was not optimized by the edge node 530 but was communicated to the central node 510 and thus is an example of a local information variable.

In some embodiments, the central node 510 includes a variable map 515 which corresponds to the variable map 415. The variable map 515 specifies a function 515A that the edge node 520 uses to access the variable 506A. This variable map 515 may be communicated to the edge node 520 when the local train variable list and the federation variable list are communicated to the edge node 520 as shown at 541. The variable map 515 also specifies a function 515B that the edge node 530 uses to access the variable 506B. This variable map 515 may be communicated to the edge node 530 when the local train variable list and the federation variable list are communicated to the edge node 530 as shown at 542.

FIG. 5B further illustrates the federated learning cycle or round. As shown in the figure, the global model 511 has been updated with aggregated variables 501C, 502C, and 503C. The variable 501C is the aggregation of variables 501A and 501B, the variable 502C is the aggregation of variables 502A and 502B, and the variable 503C is the aggregation of variables 503A and 503B. An updated variable list 516 is communicated to the edge node 520 as shown at 545 and the edge node 530 as shown at 546. The node 520 updates the local model 521 with the aggregated variables 501C, 502C, and 503C and the node 530 updates the local model 531 with the aggregated variables 501C, 502C, and 503C. This process can be repeated for any desired number of federated learning cycles or rounds.

The model simulation service 400 also includes a simulation analyzer 430. In operation, the simulation analyzer 430 generates an output 431. The output 431 can include visual or graphical output 432 that visually show the simulation 421. The output 431 can also include reports 433 that provide analysis data about the simulation 421. In this way, the user is able to simulate a large number of FL systems such as the simulated FL system 422 to determine optimal models to implement, optimal numbers of edge nodes to implement, and the performance of the models and edge nodes for variable optimization and aggregation using the standard variables, the locally optimized variables, the local information variables, and the frozen variables. The ellipses 434 represent that the simulation analyzer 430 can have any number of additional functions in addition to those described herein.

The model simulation service 400 includes a deployment engine 440. In operation, the deployment engine 440 allows the user to select the optimal FL system to implement based on the various simulations. The deployment engine 440 then access a central node that is connected to various edge nodes and deploys the configuration of the optimal FL system including the defined ML model so that the optimal FL system is implemented. FIG. 1, for example, illustrates a deployed FL system. Further details about deploying the selected FL system can be found in U.S. patent application Ser. No. 17/081,710 which has been incorporated herein by reference. The ellipses 445 represent that the model simulation service 400 can have any number of additional functions and/or modules in addition to those described herein.

### D. Example Methods

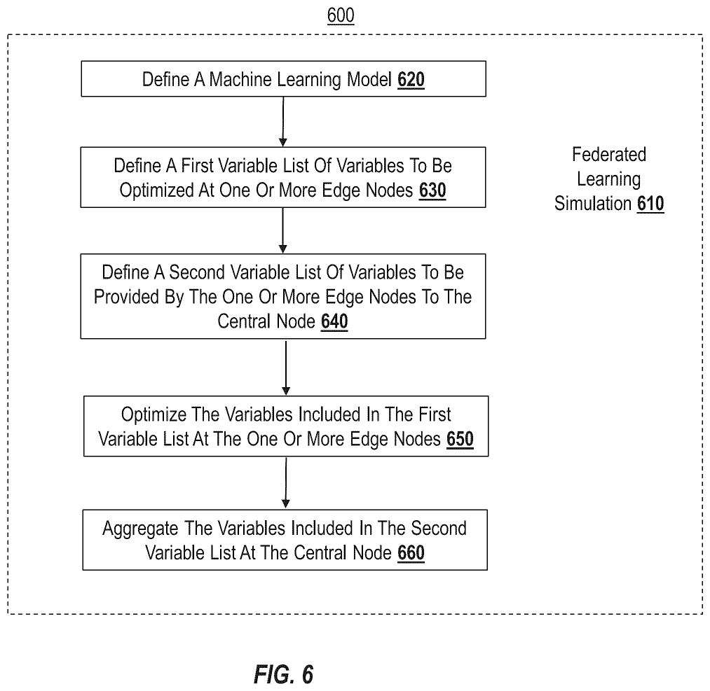

It is noted with respect to the disclosed methods, including the example method of FIG. 6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 6, an example method 600 for simulating a Federated Learning (FL) system according to some embodiments is disclosed. The method 600 will be discussed with reference to one or more of the figures previously described, although the method 600 is not limited to any particular embodiment.

The method 600 includes, for each federated learning simulation of a plurality of federated learning simulations (610): defining a machine learning model that is to be used in the federated learning simulation, the machine learning model having one or more associated variables, the defined machine learning model being implemented at one or more edge nodes of the federated learning simulation and at a central node of the federated learning simulation (620). For example, as previously described the machine learning (ML) model definition 411 defines an ML model to be used in the federated learning simulation. The ML model is implemented as a global model at the central node 510 of the federated learning simulation and as a local model at the edge nodes 520 and 530 of the federated learning simulation. The ML model has associated model variables such as variables 501-505 and related, but not directly part of the model, variables such as variables 506-508.

The method 600 includes defining a first variable list that specifies one or more of the associated variables that are to be optimized at the one or more edge nodes of the federated learning simulation (630). For example, as previously described the local train variable lists 412 or 512 specify the model variables such as variables 501-505 that are to be optimized at the edge nodes 520 and 530 of the federated learning simulation.

The method 600 includes defining a second variable list that specifies one or more of the associated variables that are to be provided by the one or more edge nodes of the federated learning simulation to the central node of the federated learning simulation (640). For example, as previously described the federation variable lists 413 or 513 specify model variables and related variables such as the variables 501, 502, 503, 505, and 506 that are sent from the edge nodes 520 and 530 to the central node 510 of the federated learning simulation.

The method 600 includes optimizing the one or more associated variables included in the first variable list at the one or more edge nodes of the federated learning simulation (650). For example, as previously described the variables such as variables 501-505 that are included in the local train variable lists 412 or 512 are optimized at the edge nodes 520 and 530 of the federated learning simulation.

The method 600 includes aggregating at the central node of the federated learning simulation the one or more associated variables that are included in the second variable list and that are provided to the central node of the federated learning simulation by the one or more edge nodes of the federated learning simulation (660). For example, as previously described the central node 510 of the federated learning simulation aggregates the variables such as the variables 501, 502, 503, 505, and 506 that are included in the federation variable list and that are provided by the edge nodes 520 and 530 of the federated learning simulation.

### E. Further Example Embodiments

Following are some further example embodiments of the invention. These are presented only by way of example and are not intended to limit the scope of the invention in any way.

Embodiment 1. A method, comprising: for each federated learning simulation of a plurality of federated learning simulations: defining a machine learning model that is to be used in the federated learning simulation, the machine learning model having one or more associated variables, the defined machine learning model being implemented at one or more edge nodes of the federated learning simulation and at a central node of the federated learning simulation; defining a first variable list that specifies one or more of the associated variables that are to be optimized at the one or more edge nodes of the federated learning simulation; defining a second list that specifies one or more of the associated variables that are to be provided by the one or more edge nodes of the federated learning simulation to the central node of the federated learning simulation; optimizing the one or more associated variables included in the first variable list at the one or more edge nodes of the federated learning simulation; and aggregating at the central node of the federated learning simulation the one or more associated variables that are included in the second variable list and that are provided to the central node of the federated learning simulation by the one or more edge nodes of the federated learning simulation.

Embodiment 2. The method of embodiment 1, further comprising: for each federated learning simulation of the plurality of federated learning simulations: defining an aggregation map that includes an aggregation function that is used by the central node of the federated learning simulation to aggregate the one or more associated variables that are included in the second variable list and that are provided to the central node of the federated learning simulation by the one or more edge nodes of the federated learning simulation

Embodiment 3: The method of any of embodiments 1-2, wherein the one or more associated variables include one or more model variables that are part of the defined machine learning model and one or more variables that are related to, but are not directly part of, the defined machine learning model.

Embodiment 4: The method of embodiment 3, wherein the one or more model variables include one or more of a weight variable, a bias variable, or a model statistical variable.

Embodiment 5: The method of embodiment 3, wherein the one or more related variables include one or more of statistical information, a number of samples used in model training, or information that is relevant to a particular edge node.

Embodiment 6: The method of any of embodiments 1-5, wherein those variables of the one or more associated variables that are included in both the first variable list and the second variable list are standard variables that are optimized at the one or more edge nodes of the federated learning simulation and aggregated at the central node of the federated learning simulation.

Embodiment 7: The method of any of embodiments 1-6, wherein those variables of the one or more associated variables that are only included in the first variable list are locally optimized variables that are optimized at the one or more edge nodes of the federated learning simulation, but are not aggregated at the central node of the federated learning simulation.

Embodiment 8: The method of any of embodiments 1-7, wherein those variables of the one or more associated variables that are only included in the second variable list are local information variables that are aggregated at the central node of the federated learning simulation, but are not optimized at the one or more edge nodes of the federated learning simulation.

Embodiment 9: The method of any of embodiments 1-8, wherein those variables of the one or more associated variables are frozen variables that are not optimized at the one or more edge nodes of the federated learning simulation and are not aggregated at the central node of the federated learning simulation.

Embodiment 10: The method of any of embodiments 1-9, further comprising: selecting an optimal one of the federated learning simulations; and deploying the defined machine learning model, the central node, and the one or more edge nodes of the optimal one of the federated learning simulations on a plurality of computing systems.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

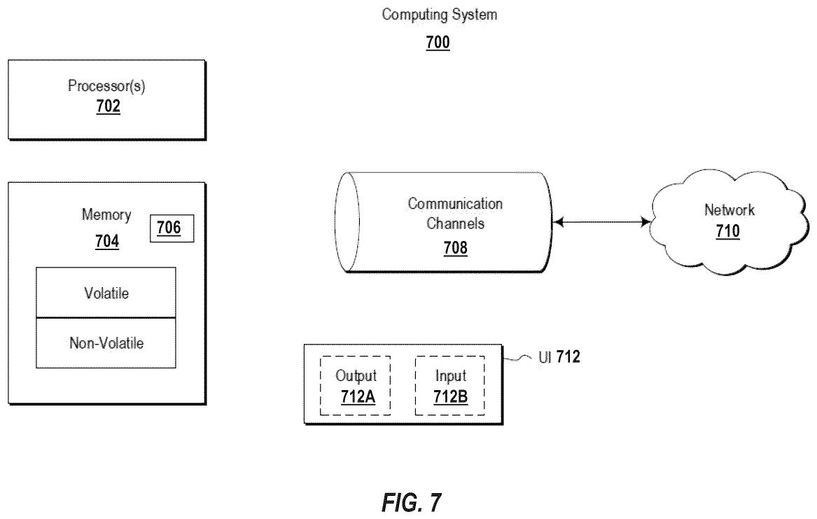

Finally, because the principles described herein may be performed in the context of a computing system some introductory discussion of a computing system will be described with respect to FIG. 7. Computing systems are now increasingly taking on a wide variety of forms. Computing systems may, for example, be hand-held devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 7, in its most basic configuration, a computing system 700 typically includes at least one hardware processing unit 702 and memory 704. The processing unit 702 may include a general-purpose processor and may also include a field-programmable gate array (FPGA), an application-specific integrated circuit (ASIC), or any other specialized circuit. The memory 704 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 700 also has thereon multiple structures often referred to as an “executable component”. For instance, memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent,” “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, holograms, and so forth. Examples of input mechanisms 712B might include, for instance, microphones, touchscreens, holograms, cameras, keyboards, mouse or other pointer input, sensors of any type, and so forth.

Embodiments described herein may comprise or utilize a special purpose or general-purpose computing system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hard-wired, wireless, or a combination of hard-wired or wireless) to a computing system, the computing system properly views the connection as a transmission medium. Transmission media can include a network and/or data links that can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively, or in addition, the computer-executable instructions may configure the computing system to perform a certain function or group of functions. The computer-executable instructions may be, for example, binaries or even instructions that undergo some translation (such as compilation) before direct execution by the processors, such as intermediate format instructions such as assembly language or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing systems, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing systems which may correspond to the computing system 700 previously described. The computing systems of the remaining figures include various components or functional blocks that may implement the various embodiments disclosed herein, as will be explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems of the remaining figures may include more or less than the components illustrated in the figures, and some of the components may be combined as circumstances warrant. Although not necessarily illustrated, the various components of the computing systems may access and/or utilize a processor and memory, such as processing unit 702 and memory 704, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
for each federated learning simulation of a plurality of federated learning simulations:
defining a machine learning model that is to be used in the federated learning simulation, the defined machine learning model having one or more associated variables, the defined machine learning model being implemented at one or more edge nodes of the federated learning simulation and at a central node of the federated learning simulation;
defining a first variable list that specifies one or more of the associated variables that are to be optimized at the one or more edge nodes of the federated learning simulation;
defining a second variable list that specifies one or more of the associated variables that are to be provided by the one or more edge nodes of the federated learning simulation to the central node of the federated learning simulation;
optimizing the one or more associated variables included in the first variable list at the one or more edge nodes of the federated learning simulation; and
aggregating at the central node of the federated learning simulation the one or more associated variables that are included in the second variable list and that are provided to the central node of the federated learning simulation by the one or more edge nodes of the federated learning simulation.

2. The method of claim 1, further comprising:
for each federated learning simulation of the plurality of federated learning simulations:
defining an aggregation map that includes an aggregation function that is used by the central node of the federated learning simulation to aggregate the one or more associated variables that are included in the second variable list and that are provided to the central node of the federated learning simulation by the one or more edge nodes of the federated learning simulation.

3. The method of claim 1, wherein the one or more associated variables include one or more model variables that are part of the defined machine learning model and one or more variables that are related to, but are not directly part of, the defined machine learning model.

4. The method of claim 3, wherein the one or more model variables include one or more of a weight variable, a bias variable, or a model statistical variable.

5. The method of claim 3, wherein the one or more related variables include one or more of statistical information, a number of samples used in model training, or information that is relevant to a particular edge node.

6. The method of claim 1, wherein those variables of the one or more associated variables that are included in both the first variable list and the second variable list are standard variables that are optimized at the one or more edge nodes of the federated learning simulation and aggregated at the central node of the federated learning simulation.

7. The method of claim 1, wherein those variables of the one or more associated variables that are only included in the first variable list are locally optimized variables that are optimized at the one or more edge nodes of the federated learning simulation, but are not aggregated at the central node of the federated learning simulation.

8. The method of claim 1, wherein those variables of the one or more associated variables that are only included in the second variable list are local information variables that are aggregated at the central node of the federated learning simulation, but are not optimized at the one or more edge nodes of the federated learning simulation.

9. The method of claim 1, wherein those variables of the one or more associated variables are frozen variables that are not optimized at the one or more edge nodes of the federated learning simulation and are not aggregated at the central node of the federated learning simulation.

10. The method of claim 1, further comprising:
selecting an optimal one of the federated learning simulations; and
deploying the defined machine learning model, the central node, and the one or more edge nodes of the optimal one of the federated learning simulations on a plurality of computing systems.

11. A non-transitory storage medium having stored therein instructions that are executable by one or more hardware processors to perform operations comprising:
for each federated learning simulation of a plurality of federated learning simulations:
defining a machine learning model that is to be used in the federated learning simulation, the defined machine learning model having one or more associated variables, the defined machine learning model being implemented at one or more edge nodes of the federated learning simulation and at a central node of the federated learning simulation;
defining a first variable list that specifies one or more of the associated variables that are to be optimized at the one or more edge nodes of the federated learning simulation;
defining a second variable list that specifies one or more of the associated variables that are to be provided by the one or more edge nodes of the federated learning simulation to the central node of the federated learning simulation;
optimizing the one or more associated variables included in the first variable list at the one or more edge nodes of the federated learning simulation; and
aggregating at the central node of the federated learning simulation the one or more associated variables that are included in the second variable list and that are provided to the central node of the federated learning simulation by the one or more edge nodes of the federated learning simulation.

12. The non-transitory storage medium of claim 11, further comprising the following operation:
for each federated learning simulation of the plurality of federated learning simulations:
defining an aggregation map that includes an aggregation function that is used by the central node of the federated learning simulation to aggregate the one or more associated variables that are included in the second variable list and that are provided to the central node of the federated learning simulation by the one or more edge nodes of the federated learning simulation.

13. The non-transitory storage medium of claim 11, wherein the one or more associated variables include one or more model variables that are part of the defined machine learning model and one or more variables that are related to, but are not directly part of, the defined machine learning model.

14. The non-transitory storage medium of claim 13, wherein the one or more model variables include one or more of a weight variable, a bias variable, or a model statistical variable.

15. The non-transitory storage medium of claim 13, wherein the one or more related variables include one or more of statistical information, a number of samples used in model training, or information that is relevant to a particular edge node.

16. The non-transitory storage medium of claim 11, wherein those variables of the one or more associated variables that are included in both the first variable list and the second variable list are standard variables that are optimized at the one or more edge nodes of the federated learning simulation and aggregated at the central node of the federated learning simulation.

17. The non-transitory storage medium of claim 11, wherein those variables of the one or more associated variables that are only included in the first variable list are locally optimized variables that are optimized at the one or more edge nodes of the federated learning simulation, but are not aggregated at the central node of the federated learning simulation.

18. The non-transitory storage medium of claim 11, wherein those variables of the one or more associated variables that are only included in the second variable list are local information variables that are aggregated at the central node of the federated learning simulation, but are not optimized at the one or more edge nodes of the federated learning simulation.

19. The non-transitory storage medium of claim 11, wherein those variables of the one or more associated variables are frozen variables that are not optimized at the one or more edge nodes of the federated learning simulation and are not aggregated at the central node of the federated learning simulation.

20. The non-transitory storage medium of claim 11, further comprising the following operation:
selecting an optimal one of the federated learning simulations; and
deploying the defined machine learning model, the central node, and the one or more edge nodes of the optimal one of the federated learning simulations on a plurality of computing systems.
